(19) United States
(12) Patent Application Publication
(10) Pub. No.: US 2002/0146102 A1
(43) Pub. Date: Oct. 10, 2002

(54) Method and system for multi-provider competitive telecommunications services

(76) Inventor: Alexander C. Lang, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 10/101,849

(22) Filed: Mar. 21, 2002

Related U.S. Application Data
(60) Provisional application No. 60/277,628, filed on Mar. 22, 2001.

(51) Int. Cl. H04M 15/00

(52) U.S. Cl. 379/114.02; 379/114.12

(57) ABSTRACT

A system for enabling competitive bidding for provision of telecommunications services provides an interface for initiating communications sessions, a communications request queue, a management application for managing the communications request queue, and a communications service provider interface for providing the communications service providers with selective access to communications request messages received through the session initiation interface. The communications service providers are permitted to post rates for respective communications services in a rates database. The rates are used to select a least cost communications service provider for each communications request message received. Scheduled communications request messages are displayed for any communications request message that they are qualified to serve.

### CROSS-REFERENCE TO RELATED APPLICATIONS

This application claims the benefit of priority under 35 U.S.C. 119(e) to United States Application Ser. No. 60/277,628, filed Mar. 22, 2001.

### MICROFICHE APPENDIX

Not Applicable.

### TECHNICAL FIELD

The present invention relates to the field of competitive telecommunications service provision; and, in particular, to a method and system for enabling multi-provider competitive telecommunications services.

### BACKGROUND OF THE INVENTION

As is known in the art, public telecommunications networks are a patchwork of independently owned and operated telecommunications subnetworks that interwork because of standardized call processing techniques and interconnected signaling systems. The owners and operators of respective telecommunications subnetworks enter into service level agreements (SLAs) in order to provide services beyond the reach of their own subnetwork. The SLAs permit the owners and operators of telecommunications subnetworks to offer services at a pre-established rate to the subscribers they serve.

The rapid development of telecommunications equipment for converged voice and data networks has led to unprecedented equipment and network flexibility. There are now more independent telecommunications subnetwork owners and operators than ever before, and there are more services, grades of service, and service features available, than ever before. Furthermore, there is more capacity in the public telecommunications networks than ever before. However, in spite of the available service options and capacity, most subscribers still only have access to those service options through a single dedicated service provider that is generally in a position to dictate which service features and options are available, and at what rate. Consequently, the opportunity for competition in the telecommunications industry revolves around winning subscribers, rather than providing a best rate for any selected communications session.

While systems have been invented to permit competition among communications service providers (such as the owners and operators of the subnetworks), the benefits of the competition have not been extended to service subscribers. For example, U.S. Pat. No. 6,144,727 entitled METHOD AND SYSTEM FOR GLOBAL TELECOMMUNICATIONS NETWORK MANAGEMENT AND DISPLAY OF MARKET-PRICE INFORMATION, which issued to Mashinsky on Nov. 7, 2000, teaches a method for owners and operators of telecommunications equipment to dynamically buy and sell use of equipment, in accordance with supply and demand. The owners and operators therefore are provided with an ability to buy and sell blocks of bandwidth, but this ability is not provided to individuals who wish to use telecommunications services.

It is also known from U.S. Pat. No. 5,802,502, entitled SYSTEM FOR SELECTIVE COMMUNICATION CONNECTION BASED ON TRANSACTION PRICING SIGNALS, which issued to Gell, Sep. 1, 1998, to use embedded circuits in telecommunications devices to automatically poll for a best rate prior to initiation of a communications session. Unfortunately this method requires the telecommunications devices to include particular circuitry, which precludes most current telecommunications equipment.

There therefore remains a need for a system and method that permits communications service providers from all corners of the public telecommunications network to bid for an opportunity to effect communications services requested by service subscribers or service subscriber equipment.

### SUMMARY OF THE INVENTION

Therefore an object of the invention is to provide a method and system for enabling communications service providers from all corners of the public telecommunications network to bid for an opportunity to service communications services requested by service subscribers or service subscriber equipment.

Conversely the invention provides users of telecommunications devices to request communications services from a dynamic and competitive marketplace.

Accordingly, a system for enabling users of telecommunications devices to request a communications session is provided. The system includes an interface for receiving from the users, communications request messages. The communications request messages may conform to one of a number of specified formats so that all manner of telecommunications devices can issue the communications requests. The system further includes a communications queue master adapted to assign a respective communications service provider identifier selected from a master rate table to a communications request received from the interface. The assignment is guided by call parameters optionally specified in the communications request. In particular, a criteria specified in the communications request may be used to determine a type and quality of service requested, and to guide selection of the communications service provider that may provide a service requested in the communications request. The communications request messages with assigned identifiers are posted to a communications request queue of the system where, at an allotted time, may be retrieved by a communications service provider identified by the identifier.

The interface is preferably adapted to receive the communications request messages from a plurality of different types of wireless and wireline telecommunications devices, and to parse them parse to extract a type and quality of service for the communications session, communications addresses for all invited participants in the communications session. Optionally the communications request messages may further specify any one of a communications service provider to effect the communications service, a scheduled time for the communications session, and the criteria for guiding the selection of the communications service provider to service the communications session.

The master rate tables are preferably adapted to store, for each type and quality of service supported by the system, a communications service provider identifier and an associated rate. The associated rate stored for each type and quality of service is the rate offered for the respective type and quality of service by the communications service provider. The associated rate is the lowest cost rate for the service offered by any of the communications service providers that are active and registered to provide rate tables to the system, and qualified to offer the respective type and quality of service.

The system may further comprise a queue rate table application adapted to receive changes in the status of and posted rate tables associated with respective communications service providers, and further adapted to modify the master rate tables, as required by the changes.

The communications queue master is generally responsible for managing communications requests in a bidding queue. The communications queue master identifies communications request messages that are open for bidding, calculates a time sensitivity for each of the respective identified communications request messages that are open for bidding, and posts the communications request messages to a bidding queue for a time period determined by the time sensitivity.

The communications service providers access the system via a communications service provider interface. The communications service provider interface enables each of the communications service providers to poll the communications request queue to retrieve communications request messages with their respective identifiers, bid on the communications request messages in the bidding queue, and request modification of rate table records that store rates for communications services that the communications service provider offers to the users of the telecommunications devices.

The communications queue master further comprises a bid management application adapted to receive, from a bidding communications service provider, a new bid for a communications request queued in the bidding queue, determine if the new bid is lower than a current bid for the communications request queued in the bidding queue, verify that the bidding communications service provider is qualified to provide the quality and type of service specified in the communications request, if the new bid is lower than the current bid, and replace the current bid and a current communications service provider identifier associated with the current bid with the new bid and an identifier associated with the bidding communications service provider, if the communications service provider is deemed qualified.

The communications service provider interface is preferably further adapted to provide the communications service providers with on-demand access to the bidding queue. It is therefore adapted to receive and parse requests for viewing communications requests in the bidding queue from communications service providers, and reply with the information. Preferably the communications requests shown to the communications service providers are masked to provide enough information to permit the communications service provider to determine a cost of providing the service requested by the service request, but not enough information to permit the service provider to effect the communications service. The communications service provider interface is further adapted to receive bids and relay the bids to the bid management application. Preferably the communications service provider interface is further adapted to selectively retrieve the information related to any queued communications request that meets at least one specified criteria.

The communications queue master is preferably further adapted to encrypt each communications request posted in the communications request queue, so that only the communications service provider identified by the respective identifier, can decrypt, retrieve and view the communications request. Alternatively the communications queue master may issue the communications requests directly to the selected communications service provider, when the communications session requested in the communications requests is imminent.

The system preferably further comprises a system monitor for registering the respective communications service providers, ensuring that communications service providers post records in the rate tables only for types of services they are qualified to provide, and monitoring performance of communications service providers to ensure that they perform services to a level and quality of service that they specify.

The communications queue master is preferably further adapted to identify communications request messages that require billing, maintain a list of the identified communications request messages that have been retrieved from the communications request queue, and are awaiting session completion information from the retrieving communications service provider, and issue session completion information for respective communications request messages to a communications billing system. The system therefore further comprises the communications billing system for generating a billing record for the respective communications request messages.

Also accordingly a method is provided. The method provides a marketplace for competitive bidding on communications services. The method involves accepting communications request messages from a plurality of communications device users, receiving rate tables from the communications service providers, for respective types of services; and selecting for each communications request, a respective communications service provider having a best current rate for effecting the respective communications request messages. The communications requests are then posted with an identifier of respective selected communications service providers and associated rates to a communications request queue, where the respective communications service providers can retrieve their communications request messages to effect the respective requested communications services.

Accepting the communications request involves receiving a communications request that conforms with one of a plurality of formats corresponding to messages sent from a plurality of wireless and wireline communications devices, identifying a one of the plurality of formats to which the communications request conforms, and parsing the communications request according to the format to which the communications request conforms.

Parsing further involves determining a type of communications session requested in the communications request, extracting data required to establish the type of communications session, and identifying any optional parameters for the call.

Optional parameters may include any of the following: a preselected communications service provider; a scheduled time for the communications session; a quality of service for the communications session; and a criterion for selecting a best communications service provider to effect the communications service requested by the communications request.

Selecting may further involve determining a method of assigning a communications service provider identifier to the communications request, in dependence upon the optional parameters, and applying the determined method to assign the communications service provider identifier to the communications request. So for example, a method wherein the step of determining the method involves determining if a preselected communications service provider is specified in the communications request, and if a time sensitivity derived from the scheduled time, is below a threshold, can provide different methods of selecting a communications service provider accordingly. The comparison with the threshold is used to determine if sufficient time remains until the communications session is requested to begin to allow for bidding on the communications request. Accordingly, if insufficient time remains and no communications service provider is preselected, the method for selection to apply may involve looking up the type of communications session requested a master rate table containing a lowest available rate, and identifier of the communications service provider offering a lowest available rate, for the type of communications session. If a preselected communications service provider is specified in the communications request, the method for selection may involve looking up in a rate tables database a rate offered for the type of communications session requested by a preselected communications service provider. Finally, if sufficient time remains and no preselected communications service provider is specified in the communications request, the method of selection may involve posting the communications request in a bidding queue for a duration determined in dependence upon the time sensitivity.

In accordance with an aspect of the invention, the method involves a step of permitting the communications service providers to poll the bidding queue, and inspect enough of each of the communications requests in the bidding queue to ascertain a cost of providing the communications session requested but not enough to effect the communications session, and accepting any bids from communications service providers for providing the communications sessions. When a new bid is received, the method involves replacing a current bid in the bidding queue for a communications request if the new bid is accepted from a communications service provider that is qualified to offer the communications session, and offers a lower rate for the service request.

The method preferably further involves dynamically maintaining the rate tables database, by permitting the communications service providers to view a current copy of the master rate tables, accepting from a communications service provider a modification to a the communications service provider's rate tables, and updating the rate tables database accordingly.

The master rate tables are also preferably dynamically maintained. This involves identifying changes to the rates for services effected by the updating of the rate tables database, and revising the master rate tables to ensure that the rates posted for each type and quality of service is still a best rate offered by any qualified communications service provider for the type and quality of service, and that the rates are still offered by the respective communications service providers.

The step of posting the communications request messages preferably involves encrypting the communications request messages so that only the respective selected communications service providers can decrypt the communications request messages.

Preferably the method also involves providing an interface that enables the communications service providers to logon and poll the communications request queue, and monitoring the polling of the communications request queue to detect when a communications service provider becomes inactive, and when a communications request queue becomes active by logging on. Then when a status of a communications service provider changes, a status of the communications service provider in the rate tables database is changed accordingly, and the master rate tables is updated, to make sure that the rates for services in the master rate tables are offered by active communications service providers, and that the rates for services are the best offered by all active communications service providers qualified to effect the respective services.

The method preferably further involves providing a communications service provider monitor for registering communications service providers, ensuring that the communications service providers are qualified to offer rate tables as bids for respective types of services, and rescind active status to communications service providers that have consistently failed to retrieve the communications requests that bear their respective identifiers in the communications request queue, or otherwise consistently failed to provide the communications services requested.

### BRIEF DESCRIPTION OF THE DRAWINGS

Further features and advantages of the present invention will become apparent from the following detailed description, taken in combination with the appended drawings, in which:

FIG. 1 is a schematic block diagram of principal elements of a competitive bidding system in accordance with the invention;

FIG. 2 is a flow chart illustrating principal steps involved in processing a communications request in accordance with the invention;

FIG. 3 is a flow chart illustrating principal steps involved in modifying rates offered by a communications service provider, in accordance with the invention;

FIG. 4 is a flow chart illustrating principal steps involved in bidding for provision of a communications request, in accordance with the invention; and

FIG. 5 is a flow chart illustrating principal steps involved in retrieving a communications request and effecting a communications session, in accordance with the present invention.

It should be noted that throughout the appended drawings, like features are identified by like reference numerals.

### DETAILED DESCRIPTION OF THE PREFERRED EMBODIMENT

The invention provides methods and a system for enabling a telecommunications service provider to bid for servicing of scheduled or unscheduled request messages for telecommunications sessions. The communications sessions are requested by users of telecommunications devices using communications request messages sent to the system through a data network, such as the Internet.

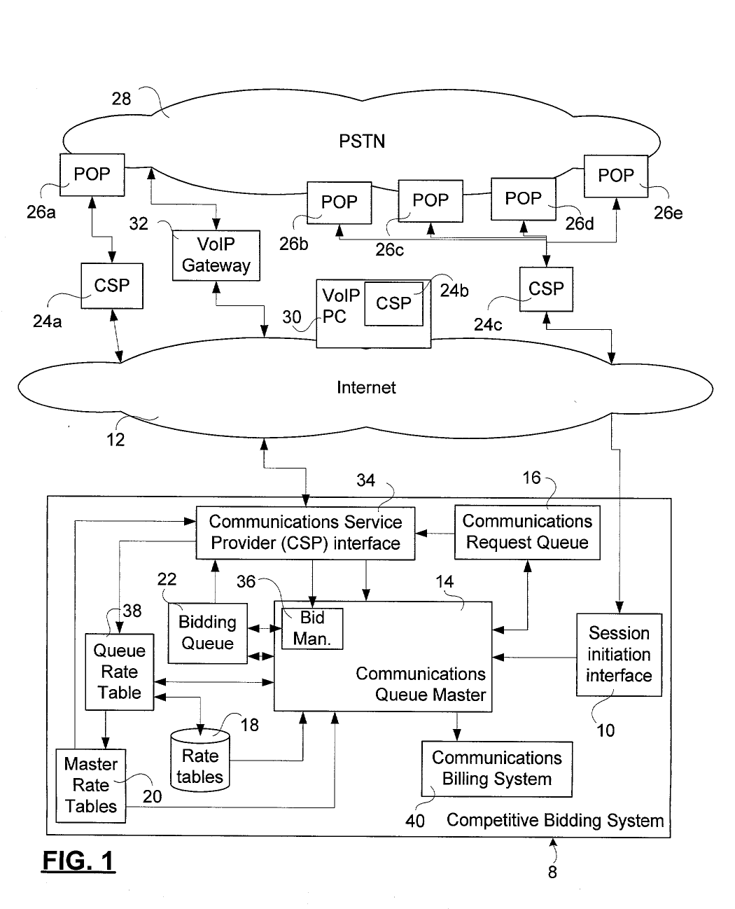

FIG. 1 illustrates an embodiment of a competitive bidding system 8 in accordance with the invention. A session initiation interface 10 is provisioned to receive communications request messages from a data network, such as the Internet 12, and to reformat, as required, the communications request messages and relay the communications request messages to a communications queue master 14. The communications queue master 14 processes the communications request messages. The communications queue master 14 is therefore provisioned with an algorithm for determining a lowest rate offered by a registered and active communications service provider for a particular type and quality of service requested by each communications request message, and to post each communications request to a communications request queue 16, where the selected registered and active communications service provider can retrieve the communications request, and effect connections to provide the requested service.

Communications request messages, in accordance with the present invention, are messages that conform to a predefined format, or any one of a number of predefined message formats, that provides information required to effect a communications service of a predetermined type and quality of service. Each message format permits a number of optional parameters to be specified. If a communications request message is formulated using a device other than the device to be used for the requested communications service, the network address/directory number of the originating equipment must be specified, as well as network addresses/directory numbers for each other party invited to participate in the communications session. A number of other parameters may also be specified in a communications request message, including a communications session type, a preselected communications service provider, a bandwidth requirement, service features, a quality of service, or other parameters related to the communications session. The communications request messages may be text or data messages sent from devices such as private branch exchanges (PBXs); telecommunications network switches; personal communications or data devices; worldwide web interfaces, or any other devices that can be used to formulate and send a communications request message to the session initiation interface 10.

There are several ways in which the communications queue master 14 is adapted to identify a lowest rate for a given communications request in the exemplary embodiment described below. The first is applied in dependence upon criteria specified in the communications request. If, the communications request message indicates that a communications service provider is preselected, the communications queue master 14 determines a service type requested by the given communications request. The communications request message, may specify a communications session type, a quality of service for the session, and calling areas of participants invited to the session, for example. The communications queue master 14 then accesses a rate tables database 18 to retrieve a rate (R) that the preselected communications service provider (identified by its communications service provider identifier (CSP-ID)), charges for the service. The communications queue master 14 binds the pair (CSP-ID,R) to the communications request, which is then posted to the communications request queue 16.

If a communications service provider is not preselected, and the service requested by a communications request message is for a communications session that is to begin immediately, or near enough to immediately that a bid process for the communications request message is not practical, the communications queue master 14 determines the type and quality of service requested, and then accesses a master rate table 20 to retrieve a rate (R), and a communications service provider identifier (CSP-ID) associated with the service type/quality of service. The communications queue master 14 binds the pair (CSP-ID,R) to the communications request, and posts the communications request to the communications request queue 16.

Finally, if the communications request is for a scheduled communications session, and a communications service provider is not preselected, the communications queue master 14 calculates a time sensitivity of the communications request, selects a default service provider for the communications request and posts the communications request to a bidding queue 22 for a period of time determined by the time sensitivity. While the communications request messages are in the bidding queue 22, a communications service provider (three are illustrated in FIG. 1, namely CSPs 24a-c; herein collectively referred to as a communications service provider 24) that is registered, and actively polling the communications request queue 16, may offer a lower bid for an opportunity to service the communications request.

The communications request messages that the communications service providers 24 can view in the bidding queue 22 are preferably masked to an extent that they provide enough information to enable service providers to compute a cost of providing the communications service requested, but not enough information to effect the communications request messages, or to expose private information related to the communications session requested. For example, equipment portions of directory numbers of participants to a call (the last four digits in a telephone number) may be masked to ensure privacy of the callers, and to prevent the communications service providers 24 from identifying the parties to the call.

When the time for effecting the communications request is imminent, the communications request is removed from the bidding queue 22 by the communications queue master 14. The communications request is then posted to the communications request queue 16 bearing the current pair (CSP-ID,R), representing either the default service provider selected by the communications queue master 14, or any subsequent lower bidder for the service.

The communications queue master 14 also monitors session initiation times associated with the respective communications request messages in the communications request queue 16. Each communications request that is for immediate (unscheduled) processing, or has been removed from the bidding queue 22 just prior to session initiation time, is marked for retrieval by the identified communications service provider 24. Other communications request messages, for example, those that have an associated communications service provider 24, but are scheduled for a later time, are not marked for retrieval until the scheduled session time is imminent. The communications queue master 14 is responsible for marking the respective communications requests in the communications request queue 16 for retrieval by the designated communications service providers 24.

In order to decrease demand on the communications queue master 14, only one communications request queue 16 is maintained for each instance of the communications queue master 14. More than one instance of the communications queue master may be instantiated to maintain a respective communications request queue, if required. It is also preferable that the communications queue master 14 encrypt each communications request in the communications request queue so that only the associated communications service provider 24 can decipher it. Each registered communications service provider is therefore issued a private key upon registration with the competitive bidding system 8, that the service provider uses to decrypt communications requests that it is to service. Consequently communications queue master 14 is not required to issue communications request messages to the respective communications service providers 24, and the communications request queue 16 requires no policing function.

The communications service providers 24 each has access to telecommunications equipment. The communications service providers 24 include carriers that have extensive telecommunications subnetworks, local access service providers, and even individual switches that are connected with other subnetworks that have service level agreements of some kind with other subnetworks. Illustrated in FIG. 1 are three communications service providers 24a,b,c. Communications service provider 24a is a service provider that has a single point of presence (POP) 26a in a public switched telephone network (PSTN) 28. The POP 26a is an example of a POP 26 in the PSTN 28 that enables a communications service provider 24 to exchange call control signaling messages with other switches in the PSTN 28, in order to initiate the setup of telephone calls. Having just one POP 26a, communications service provider 24a currently has little access to a broad market. Generally such communications service providers have great competitive advantage over other communications service providers 24 for calls that originate or terminate locally. However in some cases, they may have service level agreements that enable them to offer a lowest rate on calls made between two remote calling regions. It is therefore in the interest of competition, and smaller communications service providers 24, that bidding for an opportunity to service communications sessions be provided.

Communications service provider 24b operates a voice over Internet protocol (VOIP) server 30. The server 30 may receive request messages for dedicated traffic in a wide range of formats and data rates. It is important to understand that connections that support communications sessions crisscross between the Internet 12 and the PSTN 28, and the capabilities of current equipment blurs the distinction between the two networks. The separation of the PSTN 28 and the Internet 12 is currently somewhat artificial, and as time progresses, the integration of these networks is expected to further obfuscate the boundary between them.

The service features and types of communications services provided by the VOIP server 30 is assumed to include long distance telephone service, video sessions, multicast and broadcast sessions, telephone conferences, virtual private network sessions, and data communications sessions. Some of these communications services may require the use of the PSTN 28, and in a manner known in the art, this access is provided via VOIP gateways, such as VOIP gateway 32.

Communications service provider 24c is a carrier having a plurality of POPs (four illustrated, POPs 26b,c,d,e) . Such a communications service provider 24 is able to offer telecommunications services to a broad customer base.

It will be understood by those of skill in the art that there are a large number of communications service providers 24, which include the owners/operators of telecommunications subnetworks, carriers, and resellers of telecommunications services. In accordance with the present invention, the only requirement for becoming a communications service provider 24, is to be able to effect the initiation of two legs of a communications session, and to bridge the respective legs to complete a dedicated connection to support a communications session. Communications service provider 24 equipment may therefore include routers and central office switches, wireless devices, and all kinds of equipment in between. A few examples of such equipment include: local end offices; routers; VOIP servers; gateways; private branch exchanges; dialers; and personal computers with access to a public communications network.

The communications service providers 24 are registered to use the competitive bidding system 8, and access the network through a CSP interface 34. The CSP interface 34 is a point of access to the competitive bidding system 8 for the purposes of providing the communications service providers 24 with access to the communications request queue 16, a queue rate table application 38, the bidding queue 22, and a bid management application 36 associated with the communications queue master 14.

In accordance with the present invention, the communications service providers 24 access the communications request queue 16 to retrieve the communications request messages, as explained above. The communications request queue 16 is polled via the CSP interface 34. The CSP interface 34 is responsible for informing the queue rate table application 38 if a communications service provider 24 starts or stops polling the communications request queue 16. The queue rate table application 38 declares a communications service provider 24 inactive if it stops polling, and changes the status of the communications service provider 24 in the rate tables database 18. The queue rate table application 38 also updates the master rate tables 20, if required, when the status of a communications service provider 24 changes, and notifies the communications queue master 14 of the change. The communications queue master 14 must then identify any communications requests the communications request queue 16 and the bidding queue 22 that are associated with the inactive communications service provider 24. Any communications requests that are found may either be treated as an unretrieved communications request, the handling of which is explained below in some detail. Alternatively, if time permits, the communications queue master 14 may identify another communications service provider 24 to handle the communications request using either the rate tables 18, or the master rate tables 20, once the queue rate table application 38 has revised them.

Unretrieved communications request messages may be handled in any number of ways. In accordance with the invention, one or more default communications service providers 24 that are collectively capable of providing any type of communications service that the competitive bidding system 8 accepts, is responsible for handling unretrieved communications request messages. The rate at which the unretrieved request messages are serviced may be the specified rate, a default rate for the type of communications service requested, or a current rate for the service that the default communications service provider 24 is offering.

Each communications service provider 24 can modify the rates they charge for any of the types of communications services they are qualified to offer. The CSP interface 34 is adapted to forward request messages for rate modifications received from the respective communications service providers 24 to the queue rate table application 38. A modification of the rate table by a communications service provider 24 is handled in much the same way as a detection of a change in status of the communications service provider 24. The queue rate table application 38 receives a message from the CSP interface 34 indicating the change(s) in the rate table(s), and then updates the appropriate rate table records associated with the communications service provider 24 in the rate tables database 18. The changed records in the rate table(s) are used to modify the master rate tables 20, if appropriate, and when this is complete, the queue rate table application 38 requests that the communications queue master 14 make necessary changes to any communications request messages pending in the communications request queue 16 and the bidding queue 22, that are not marked for retrieval. If a new rate posted for a particular type and quality of service by a communications service provider 24, is lower than the rate in the master rate tables 20 for the particular type and quality of communications service, the master rate table 20 is updated. After the update, one or more communications request messages in the bidding queue 22 or the communications request queue 16 for that type and quality of service may be at a higher rate. As long as the one or more communications request messages in the communications request queue 16 are not marked for retrieval, the lower rate is applied to the communications request, and the encryption, rate and CSP-ID are duly changed.

The active communications service providers 24 are also able to retrieve a current copy of the master rate tables 20 via the CSP interface 34, mediated by the queue rate table application 38. This way the communications service providers 24 can predict or monitor a volume of request messages they are servicing, and adjust their rate competitively with respect to the other communications service providers 24.

The CSP interface 34 also enables the communications service providers 24 to bid on individual communications request messages in the bidding queue 22. Thus the CSP interface 34 is adapted to poll the bidding queue 22, permitting the communications service provider 24 to view public information about pending communications request messages in the bidding queue 22. As was explained above, the communications request messages in the bidding queue 22 that the communications service provider 24 is permitted to view are partially masked to protect privacy of the requesting party. This masking is performed by the CSP interface 34, for example. Bids received by respective 24 communications service providers 24 are forwarded to the bid management application 36. The bid management application 36 is a component of the communications queue master 14 and is therefore responsible for managing the communications request messages in the bidding queue 22. The bid management application 36 is adapted to verify the qualifications of the communications service provider 24 making a request to ensure that only those communications service providers 24 qualified to effect the type or quality of service-requested in a communications request in the bidding queue 22, are able to bid on the communications request. If the communications request message is still in the bidding queue 22 when a bid is received, and the bid is lower than a current bid, the bid management application 36 replaces the current rate for the specified communications request with the lower bid rate, and changes the communications service provider identifier (CSP-ID).

There are a number of billing arrangements that may be used to collect payment for the communications services rendered in response to the communications request messages. As almost all communications service users are subscribers to particular local service, long distance, and/or data network access provider, billing arrangements are already provisioned by at least one communications service provider 24 associated with the user. If the communications service provider 24 is registered with the competitive bidding system 8, the communications service provider 24 may serve as a billing agent for the communications sessions. Alternatively, the competitive bidding system 8 assumes responsibility for billing for all communications sessions, in which case it will be necessary that any communications service provider 24 that services a communications request return billing information to the competitive bidding system 8, after the communications session is terminated. The competitive bidding system 8 may require users to be subscribers and therefore provide a billing relationship with the competitive bidding system 8 in a known manner. Alternatively, a user may specify a preselected communications service provider 24 to effect the communications service requested in the communications request, so that the billing for the communications service is billed to an existing account with the preselected communications service provider 24. The advantages for such a user (who is a subscriber to the preselected communications service provider 24) is that the user gets best current rates posted by the communications service provider 24, which are expected to fluctuate below rates normally provided by the communications service provider 24. The user can therefore benefit from the best rates offered by the communications service provider 24 at the time when each communications service request is serviced.

In accordance with the present invention, it is assumed that the competitive bidding system 8 is responsible for billing for all communications services effected in response to communications request messages even if the communications request message specifies a preselected communications service provider 24. Accordingly, the communications queue master 14 is adapted to receive session completion messages containing billing data via the CSP interface 34, and forward the session completion information to a communications billing system 40 that generates a billing transaction for the communications services rendered.

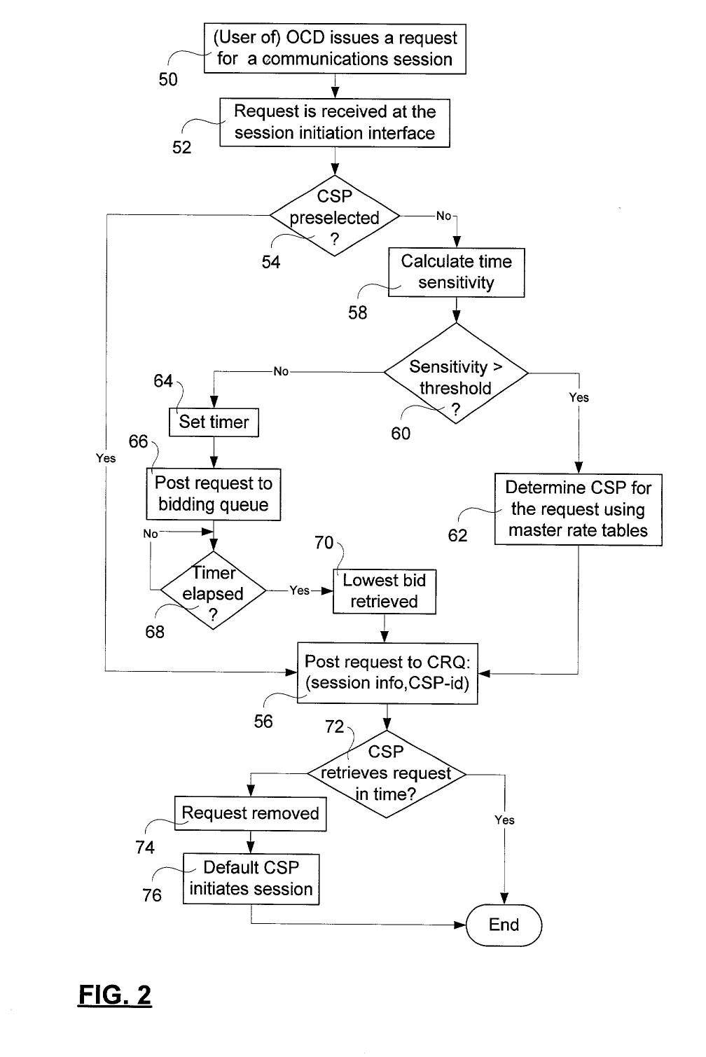

FIG. 2 illustrates principal steps involved in processing a communications request in accordance with the present invention. In step 50, a user, or a system set up for or by the user, formulates a communications request message, and forwards the message to the session initiation interface 10. This can be performed in any number of ways that are understood by persons skilled in the art. For example, communications session request messages can be issued by a personal communications device, or a private branch exchange when a user of an extension dials a toll number, and so on. Any number of devices and systems can generate the communications session requests, including computing equipment requesting a data session.

In step 52, the request is received at the session initiation interface 10 (SII). The session initiation interface 10 may reformat the communications request d message, identify incomplete communications request messages, access a database of users to complete incomplete communications request messages, and return error messages if required. Assuming the communications request is valid and complete, it is forwarded to the communications queue master 14. If the communications queue master 14 determines, in step 54, that a communications service provider 24 is preselected to provide the communications service requested with the communications request message, the communications queue master 14 binds a CSP-ID (and associated rate for the communications service) to the communications request, and places the communications request in the communications request queue 16 (step 56). The CSP-ID that is bound to the communications request is that of the preselected communications service provider 24, and the rate for the communications service is retrieved from the rate tables database 18, in accordance with an embodiment of the invention.

If a communications service provider 24 is not specified in the communications request message, a time sensitivity of the communications request is determined (step 58). If the time sensitivity of the communications request is less than a predetermined threshold, as determined in step 60, the communications queue master 14 retrieves a least-cost communications service provider 24 for servicing the request. The criteria for choosing the best communications service provider 24 is provided, in part at least, by the content of the communications request message. For example, the user may request a least expensive long distance call between two points, a least expensive voice quality call, a dedicated data connection with a specified bandwidth, or a telephone call with an enhanced level of security/reliability. The communications queue master 14 accesses the master rate tables 20 to identify a CSP-ID and associated rate (R) for the type and quality of communications service requested in the communications request. The communications queue master 14 then binds the CSP-ID, and rate to the communications request, and places it in the communications request queue 16 (step 56).

If there is time to offer the communications service providers 24 an opportunity to bid on providing the communications request, in step 64, the communications queue master 14 sets a timer governing how long the communications request can remain in the bidding queue 22 (using the computed time sensitivity), and, in step 66, the communications queue master 14 posts the communications request to the bidding queue 22. The communications request message has a best current rate (retrieved from the master rate tables 20) associated with it. When the timer has elapsed, a current bid, i.e. a lowest received bid, is retrieved (step 70), and is bound to the communications request, which is then posted to the communications request queue 16, in step 56.

Preferably, in step 56, the communications request messages posted in the communications request queue 16 are encrypted as described above. The step of posting a communications request to the communications request queue 16 generally involves determining if the rate is still the lowest for the communications session, using the master rate tables 20 or the rate tables database 18, and encrypting the communications request using the specified service provider key. If the time for effecting the communications service requested in the communications request is imminent, the communications request is posted to the communications request queue 16 and flagged for retrieval.

After the communications service provider 24 identified by the CSP-ID retrieves the communications request from the communications request queue 16, the retrieval flag is removed, and a session proceeding flag is set.

If, it is determined in step 72 that the communications request was retrieved by the communications service provider 24 from the communications request queue 16 within a specified time, the communications request is deemed processed. Otherwise, in accordance with the present invention, the communications request messages is removed from the communications request queue 16 (step 74), and the communications service is provided by a default communications service provider 24 (step 76).

FIG. 3 illustrates principal steps performed when a communications service provider 24 requests a modification of one or more of its rates in respective rate tables. In step 80, the active communications service provider 24 retrieves a copy of at least a part of the master rate tables 20 by requesting it from the CSP interface 34. The CSP interface 34, in accordance with the present embodiment, forwards the request to the queue rate table application 38, which copies at least the portion(s) of the master rate tables 20 that are relevant to the requesting communications service provider 24. The information is returned to the communications service provider 24 via the CSP interface 34, and in step 82, the communications service provider 24 receives the information, and applies a competition strategy using the available information. The communications service provider 24 may monitor the bid queue 22 to further gauge a current state of the market for a particular type or quality of service. Other valuable information can be gleaned from a current traffic load on the service provider's network facilities.

The communications service provider 24 may formulate and issue a request to change its posted rates for selected services (step 86). In accordance with one embodiment, the CSP interface 34 receives the request, forwards the content of the request to the queue rate table application 38 in an update message, and the queue rate table application 38 effects the changes to the rate table(s) associated with the communications service provider 24 (step 88). The queue rate table application 38 also updates the master rate tables 20. This involves determining if any of the changed rates affect the master rate tables 20, and updating the master rate table 20 if required. Consequently, for any rate that is decreased, records in the master rate tables 20 for corresponding types and qualities of service are inspected, and if a new rate is lower, the master rate tables 20 is updated to reflect the lower rate. The queue rate table application 38 then notifies the communications queue master 14 that the master rate tables 20 has been changed, so that it can update entries in the communications request queue 16 that are not flagged for retrieval, as explained above (step 90).

A method for changing the status of a communications service provider 24 when the communications service provider 24 either stops polling, or logs on and begins polling, involves identifying the change in status at the CSP interface 34, and forwarding the change of status in a message to the queue rate table application 38, which applies substantially the same steps as steps 86-90, described above.

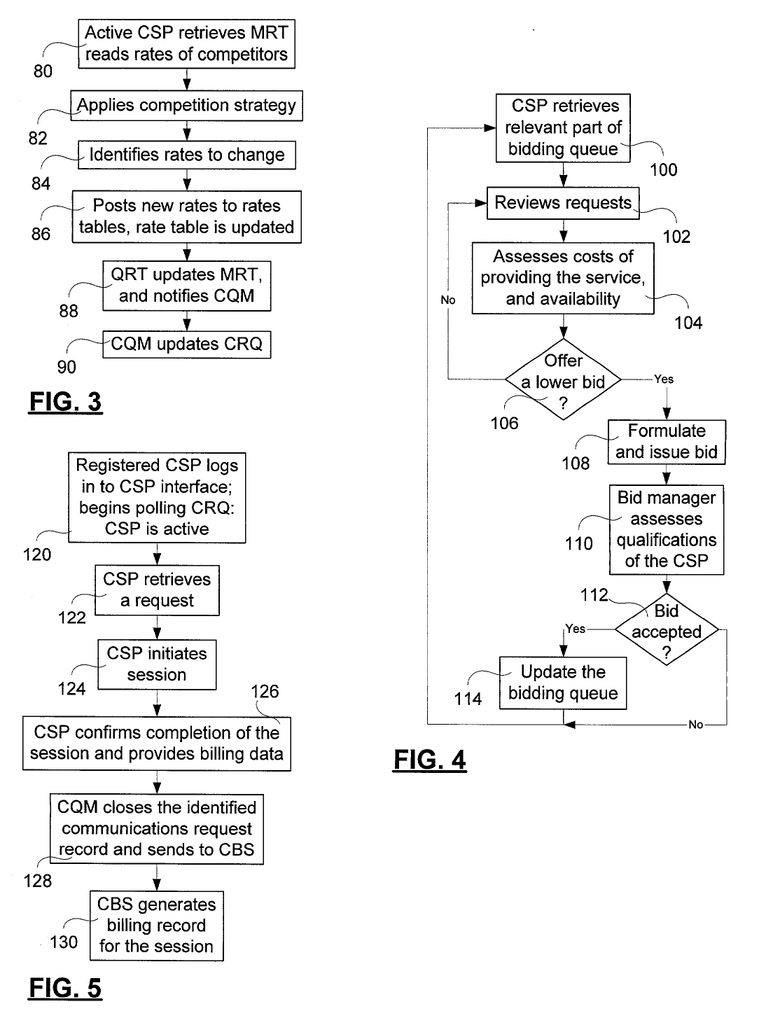

FIG. 4 illustrates principal steps involved in competitive bidding on communications requests in the bidding queue 22, in accordance with an embodiment of the invention. In step 100, an active communications service provider 24 retrieves at least relevant parts of the bidding queue 22. It is preferable that each communications service provider 24 is permitted to selectively retrieve information about only the communications request messages in the bidding queue 22 that the communications service provider is qualified to service. So, for example, the communications service provider 24 may retrieve a part of the bidding queue 22 defined by a set of search criteria. In other embodiments, the communications service provider 24 may only be provided limited access to the bidding queue 22 in dependence upon the qualifications of the communications service provider 24, or a current content of records in its rate table(s).

The communications service provider 24 then (step 102) reviews the communications request messages it has received. The communications service provider 24 may assess a cost for providing, and an availability of its equipment to support, a communications service requested by a communications request message in the bidding queue (step 104), and if it determines (in step 106) that it cannot perform the service at a lower rate, it returns to step 102. If it determines (step 106) that it can bid lower than the current rate (step 108), the communications service provider 24 formulates and issues a bid for the communications request in the bidding queue.

The bid is received at the CSP interface 34, and forwarded to the bid management application 36, which assesses the qualifications of the communications service provider 24 to handle the communications service type and quality of service requested by the communications request named in the bid (step 110). If the bid is lower than a current bid, and the communications service provider 24 is qualified, the bid is accepted in step 112. If the bid is accepted, the communications request messages in the bidding queue is updated with the bid submitted by the communications service provider 24. The communications service provider 24 can verify an outcome of the bid by again requesting that portion of the bidding queue 22 (returning to step 100).

As will be understood by those skilled in the art, the number of types of communications services available today, including all originating and destination network addresses /directory numbers is substantial. Consequently each of the communications service providers must be classified according to their qualifications, qualities of service, service feature availability, bandwidth, etc. Each of these types of service can be provided by some subset of the communications service providers 24, and a separate master rate table may be provided for each. It is efficient to organize the bidding queue 22, communications request queue 16 and master rate tables 20 into substantially independent layers that mirror an organization of the rate tables database 16.

FIG. 5 illustrates principal steps involved in a process in which a communications service provider 24 retrieves and effects a communications service in response to a communications service request, in accordance with the present invention. In step 120, the communications service provider 24 logs into the CSP interface 34, and begins polling the communications request queue 16. As the communications service provider 24 is polling the communications request queue 16, it is deemed active by the competitive bidding system 8. As soon as a marked communications request identified with its CSP-ID is located in the communications request queue 16, the communications service provider 24 retrieves it (step 122), deciphers it, and establishes a connection to support the communications session requested in the communications request (step 124). As is known in the art, the steps required to establish a connection will depend on the type of connection required, and the network(s) that the communications session is being connected through, etc. As was described above, the communications queue master 14 is preferably adapted to identify those communications request messages that it needs to bill for, and maintains a database (the communications billing system 40) to perform this billing. Assuming this communications request requires the use of the communications billing system 40, once the communications session is terminated (or perhaps at predefined intervals for on-going connection services), the communications service provider 24 issues a session completion message (session confirmation message) (step 126) to the communications queue master 14 (via the CSP interface 34). The session completion message may contain an identifier of the communications request, the start and end times of the communications session, and the expected billing for the call, for example. The session completion message identifies the communications request, and provides all of the billing data required to bill for the communications session performed in response to the communications request. The communications queue master 14 then removes the communications request from its communications request queue 16 (which has had its session proceeding flag set since it was retrieved by the communications service provider 24 in step 122), and issues the data with data about the communications request to the communications billing system 40 (step 128). In step 130 the communications billing system 40 generates a billing transaction for the communications session.

The invention therefore provides a competitive service environment open to all qualified telecommunications service providers, who compete for service opportunities based on their service qualifications and their service rates. Communications service requests can be submitted to the system by any party wishing to benefit from best-price service offerings. The system is self-propagating, self-policing and secure. Even though competitive bidding occurs, confidential information is protected and only service-essential information is released to the respective service providers. Service requesters therefore benefit from service provision at guaranteed quality of service at the lowest competitive rate.

As will be understood by those skilled in the art, the system and methods in accordance with the invention can be implemented in many different ways. The embodiments of the invention described above are therefore intended to be exemplary only. Consequently, the scope of the invention is intended to be limited solely by the scope of the appended claims.

I claim:

1. A system for enabling users of telecommunications devices to request a communications session comprising:
an interface for receiving from the users communications request messages in a specified format;
a communications queue master adapted to assign a respective communications service provider identifier selected from a master rate table to a communications request received from the interface, in accordance with criteria specified in the communications request; and
a communications request queue to which the communications request messages with assigned identifiers are posted for retrieval by a communications service provider identified by the identifier.

2. A system as claimed in claim 1 wherein the interface is adapted to receive the communications request messages from a plurality of different types of wireless and wireline telecommunications devices.

3. A system as claimed in claim 2 wherein the interface is further adapted to receive and parse communications request messages that specify a type and quality of service for the communications session, communications addresses for all invited participants in the communications session, and optionally specify any one of a communications service provider to effect the communications service, and a scheduled time for the communications session.

4. A system as claimed in claim 3 wherein the master rate tables are adapted to store, for each type and quality of service supported by the system, a communications service provider identifier and an associated rate offered by the communications service provider that offers a lowest rate for the type and quality of service.

5. A system as claimed in claim 4 further comprising a queue rate table application adapted to receive changes in the status and posted rate tables from Gil respective communications service providers, and further adapted to modify the master rate tables, as required by the changes.

6. A system as claimed in claim 4 wherein the communications queue master is further adapted to:
identify communications request messages that are open for bidding;
calculate a time sensitivity for each of the respective identified communications request messages that are open for bidding; and
post the communications request messages to a bidding queue for a time period determined by the time sensitivity.

7. A system as claimed in claim 6 further comprising a communications service provider interface for enabling each of the communications service providers to:
poll the communications request queue to retrieve communications request messages with their respective identifiers;
bid on the communications request messages in the bidding queue; and request modification of rate table records that store rates for communications services that the communications service provider offers to the users of the telecommunications devices.

8. A system as claimed in claim 7 wherein the communications queue master further comprises a bid management application adapted to:
receive, from a bidding communications service provider, a new bid for a communications request queued in the bidding queue;
determine if the new bid is lower than a current bid for the communications request queued in the bidding queue;
verify that the bidding communications service provider is qualified to provide the quality and type of service specified in the communications request, if the new bid is lower than the current bid; and
replace the current bid and a current communications service provider identifier associated with the current bid with the new bid and an identifier associated with the bidding communications service provider, if the communications service provider is deemed qualified.

9. A system as claimed in claim 8 wherein the communications service provider interface is further adapted to:
provide, in response to a request from communications service providers, for any communications request in the bidding queue, enough information to permit the communications service provider to determine a cost of providing the service requested by the service request, but not enough information to permit the service provider to effect the communications service; and
provide access to the bid management application by forwarding bids submitted by the communications service provider.

10. A system as claimed in claim 9 wherein the communications service provider interface is further adapted selectively retrieve the information related to any queued communications request that meets at least one specified criteria.

11. A system as claimed in claim 7 wherein the communications queue master is further adapted to encrypt each communications request posted in the communications request queue, so that only the communications service provider identified by the respective identifier, can decrypt, retrieve and view the communications request.

12. A system as claimed in claim 1 further comprising a system monitor adapted to: register the respective communications service providers;
ensure that communications service providers post records in the rate tables only for types of services they are qualified to provide; and
monitor performance of communications service providers to ensure that they perform services to a level and quality of service that they specify.

13. A system as claimed in claim 1 wherein the communications queue master is further adapted to:
identify communications request messages that require billing;
maintain a list of the identified communications request messages that have been retrieved from the communications request queue, and are awaiting session completion information from the retrieving communications service provider; and
issue session completion information for respective communications request messages to a communications billing system;
and the system further comprising the communications billing system for generating a billing record for the respective communications request messages.

14. A method for providing a marketplace for competitive bidding on communications services, comprising steps of:
accepting communications request messages from a plurality of communications device users;
receiving rate tables from the communications service providers, for respective types of services; and
selecting for each communications request, a respective communications service provider having a best current rate for effecting the respective communications request messages; and
posting the communications request messages with an identifier of respective selected communications service providers and associated rates to a communications request queue, where the respective communications service providers can retrieve their communications request messages to effect the respective requested communications services.

15. A method as claimed in claim 14 wherein the step of accepting comprises steps of: receiving a communications request that conforms with one of a plurality of formats corresponding to messages sent from a plurality of wireless and wireline communications devices; identifying a one of the plurality of formats to which the communications request conforms; and parsing the communications request according to the format to which the communications request conforms.

16. A method as claimed in claim 15 wherein the step of parsing further comprises steps of:
determining a type of communications session requested in the communications request;
extracting data required to establish the type of communications session; and
identifying any optional parameters for the call.

17. A method as claimed in claim 16 wherein the step of identifying any optional parameters comprises a step of determining if any of the following is specified in the communications request: a preselected communications service provider; a scheduled time for the communications session; a quality of service for the communications session; and a criterion for selecting a best communications service provider to effect the communications service requested by the communications request.

18. A method as claimed in claim 17 wherein the step of selecting further comprises steps of:
determining a method of assigning a communications service provider identifier to the communications request, in dependence upon the optional parameters; and
applying the determined method to assign the communications service provider identifier to the communications request.

19. A method as claimed in claim 18 wherein the step of determining the method comprises steps of: determining if a preselected communications service provider is specified in the communications request; and comparing a time sensitivity derived from the scheduled time, with a threshold to determine if v z sufficient time remains until the communications session is requested to begin to allow for bidding on the communications request.

20. A method as claimed in claim 19 wherein the step of applying the determined method comprises steps of: looking up the type of communications session requested a master rate table containing a lowest available rate, and identifier of the communications service provider offering a lowest available rate, for the type of communications session, if insufficient time remains and no communications service provider is preselected; looking up in a rate tables database a rate offered for the type of communications session requested by a preselected communications service provider, if a preselected communications service provider is specified in the communications request; and posting the communications request in a bidding queue for a duration determined in dependence upon the time sensitivity, if sufficient time remains and no preselected communications service provider is specified in the communications request.

21. A method as claimed in claim 20 further comprising steps of:
permitting the communications service providers to poll the bidding queue, and inspect enough of each of the communications requests in the bidding queue to ascertain a cost of providing the communications session requested but not enough to effect the communications session;
accepting any bids from communications service providers for providing the communications sessions; and
replacing a current bid in the bidding queue for a communications request if a new bid is accepted from a communications service provider that is qualified to offer the communications session, and bids a lower rate for the service request.

22. A method as claimed in claim 21 further comprising a step of maintaining the rate tables database, the step of maintaining comprising steps of: permitting the communications service providers to view a current copy of the master rate tables; accepting from a communications service provider a modification to a the communications service provider's rate tables;
updating the rate tables database accordingly.

23. A method as claimed in claim 22 further comprising a step of maintaining the master rate tables, the step of maintaining the master rate tables comprising a step of:
identifying changes to the rates for services effected by the updating of the rate tables database; and
revising the master rate tables to ensure that the rates posted for each type and quality of service is still a best rate offered by any qualified communications service provider for the type and quality of service, and that the rates are still offered by the respective communications service providers.

24. A method as claimed in claim 23 wherein the step of posting the communications request messages further comprises a step of encrypting the communications request messages so that only the respective selected communications service providers can decrypt the communications request messages.

25. A method as claimed in claim 24 further comprising steps of:
providing an interface that enables the communications service providers to logon and poll the communications request queue; and
monitoring the polling of the communications request queue to detect when a communications service provider becomes inactive, and when a communications request queue becomes active by logging on.

26. A method as claimed in claim 25 further comprising steps of: maintaining a status of each of the communications service providers in the rate tables database; and
updating the master rate tables each time a status has changed, to make sure that the rates for services in the master rate tables are offered by active communications service providers, and that the rates for services are the best offered by all active communications service providers qualified to effect the respective services.

27. A method as claimed in claim 26 further comprising a step of providing a communications service provider monitor for registering communications service providers, ensuring that the communications service providers are qualified to offer rate tables as bids for respective types of services; and rescind active status to communications service providers that have consistently failed to retrieve the communications requests that bear their respective identifiers in the communications request queue, or otherwise consistently failed to provide the communications services requested.
